(19) United States
(12) Patent Application Publication
(10) Pub. No.: US 2015/0300463 A1
(43) Pub. Date: Oct. 22, 2015

(54) IDLER OR ROLLER DEVICE

(71) Applicants: Dirk ALBRECHT, Eschweiler (DE); Frederic LIEGE, Monts (FR); Nicolas TRONQUOY, Fondettes (FR)

(72) Inventors: Dirk ALBRECHT, Eschweiler (DE); Frederic LIEGE, Monts (FR); Nicolas TRONQUOY, Fondettes (FR)

(73) Assignee: Aktiebolaget SKF, Goteborg (SE)

(21) Appl. No.: 14/688,001

(22) Filed: Apr. 16, 2015

(30) Foreign Application Priority Data
Apr. 17, 2014 (FR) 1400924

(51) Int. Cl. F16H 7/20; F16C 33/58; F16H 57/00; F16C 41/00

(52) U.S. Cl. CPC F16H 7/20; F16C 41/00; F16C 33/58; F16H 57/0031; F16H 2057/0056

(57) ABSTRACT

A tensioning roller/winder device comprising at least one roller bearing including inner and outer rings and at least one row of rolling elements between the two rings; a pulley surmounting the outer ring; and a retaining screw comprising a body and head. An abutment is provided on the body external periphery. First and second abutments are provided on the inner ring bore. The axial length between the head and the abutment equals the axial length between an inner ring radial side edge and the inner ring bore first abutment is greater than the axial length between a inner ring radial side edge opposite the screw head and the inner ring bore second abutment. The screw abutment contacts the inner ring first abutment during the body insertion into the inner ring bore in the desired direction, but contacts the inner ring second abutment during the body insertion in the undesired direction.

### CROSS REFERENCE TO RELATED APPLICATIONS

This is a Non-Provisional Patent Application, filed under the Paris Convention, claims the benefit of France Patent (FR) Application Number 1400924 filed on 17 Apr. 2014 (17.04.2014), which is incorporated herein by reference in its entirety.

### FIELD OF THE INVENTION

The present invention relates to the field of tensioning rollers or winders designed to interact with a torque transmission element such as a chain or a belt, for example a timing belt of a thermal internal combustion engine of a motor vehicle.

### PRIOR ART

Such tensioning rollers or winders generally serve to maintain a tension on the torque transmission element within a specific range at all times or to modify locally the path adopted by the latter. In such rollers, a pulley is rotatably mounted on an axis by means of a roller bearing, the roller subsequently being secured directly or indirectly to the engine block or to an element of the tensioning roller device, for example an articulated arm or an eccentric.

It is generally known to provide the roller bearing with a central bore, into which a threaded screw is inserted, the screw being intended to be screwed into a tapped opening provided on a wall of the engine block in such a way as to ensure the attachment of the roller to the engine block.

The tensioning roller comprising the pulley and the roller bearing may be preassembled at the manufacturer's site before subsequently being supplied as a construction module to the automobile engine assembly site, where the screw is subsequently inserted for the final attachment of the roller to its support.

If a roller is asymmetric, however, that is to say if it has two different radial side edges, the insertion of the screw via the radial side edge which is not provided for this purpose may result in assembly defects. For example, one side edge of the roller may be provided with an opening in such a way as to accommodate all or part of a head of the screw. If the screw is inserted via the other side edge, the threaded portion of the screw body emerging on the other side will have a greatly reduced length. The screw will thus be unable to engage by only a few threads with the threaded bore of the support for the roller, resulting in an attachment that is unsuited to shocks and vibrations.

### OBJECT AND BRIEF SUMMARY OF THE INVENTION

The invention is intended more particularly to address these problems by proposing a novel tensioning roller or winder that is simple to produce and to assemble, having a reduced number of elements, thereby ensuring easy installation of the screw.

For this purpose, the invention relates to a tensioning roller or winder device for a torque transmission element comprising at least one roller bearing having an inner ring, an outer ring and at least one row of rolling elements between the inner and outer rings, a pulley surmounting the outer ring and a retaining screw provided with a body, intended to be inserted into a central bore of the inner ring and with a screw head.

In accordance with the invention, an abutment is provided on the external periphery of the body of the screw, and a first abutment and a second abutment are provided in the bore of the inner ring. The axial length between the head and the abutment of the screw is equal to the axial length between a radial side edge of the inner ring, against which the head of the screw is intended to come into contact, and the first abutment in the bore of the inner ring. The axial length between the head and the abutment of the screw is at all times greater than the axial length between a radial side edge of the inner ring opposite the head of the screw and the second abutment in the bore of the inner ring. The abutment of the screw comes into contact with the first abutment of the inner ring at the time of the insertion of the body of the screw into the bore of the inner ring in the desired direction, but comes into contact with the second abutment of the inner ring at the time of the insertion of the body of the screw in the undesired direction.

Thanks to the invention, when the screw is inserted into the central bore of the inner ring in the desired direction, it is integrated completely into the bore until abutment of the screw head takes place against a radial side edge of the inner ring and until contact of the abutment of the screw takes place against the first abutment of the inner ring. On the other hand, when the screw is not inserted into the central bore of the inner ring in the desired direction, it is not integrated completely into the bore because the abutment of the screw comes into contact with the second abutment of the inner ring, but without the screw head coming into contact against a radial side edge of the inner ring.

In this case, the extremity of the screw carrying the head then protrudes in full or in part from the bore without the possibility of penetrating there, thereby providing the operator with an indication of incorrect insertion of the screw.

The combination of these means forms a keying system for the insertion of the screw into the tensioning roller device.

According to advantageous but not obligatory aspects of the invention, such a tensioning roller or winder device may incorporate one or a plurality of the following characterizing features considered in any technically permissible combination:

The rolling elements of the roller bearing are balls.

The rolling elements are rollers or needles.

The rolling elements of the roller bearing are maintained with more or less regular circumferential spacing by a cage.

The outer ring of the roller bearing forms the pulley of the roller device, in such a way that the outer cylindrical surface of the outer ring interacts with the torque transmission element.

The inner ring comprises, on a radial side edge, an opening of which the diameter and the depth are adapted in order to receive all or part of a head of the screw in such a way that the extremity of the screw head does not extend axially beyond the roller bearing and/or the pulley.

The first abutment and the second abutment formed in the central bore of the inner ring consist of a first shoulder and a second shoulder formed respectively on the axial extremities of a bearing, of which the internal diameter is less than the internal diameter of the bore.

The abutment formed on the body of the retaining screw consists of a shoulder formed at one axial extremity of a bearing having an external diameter greater than the external diameter of the body of the screw.

The internal diameter of the bearing in the internal bore of the inner ring is substantially equal to the external diameter of the corresponding bearing of the body of the screw.

The position of each abutment of the bearing in the bore of the inner ring is defined by an axial distance between the position of the abutment and the radial side edge of the inner ring situated on the other side of the head of the screw. The positional relationship between this axial distance in the position of the abutment and the axial length of the internal bore, between the radial side edge of the inner ring situated on the other side of the head of the screw, and the radial side edge of the inner ring against which the head of the screw is intended to come into contact lies in the range between 0 and 0.5.

The position of the first abutment of the bearing in the bore of the inner ring is positioned in a positional relationship that is preferably equal to 0.35.

The position of the second abutment of the bearing in the bore of the inner ring is positioned in a positional relationship that is preferably equal to 0.

The second abutment is a shoulder formed at the junction between the bearing in the bore and the radial side edge of the inner ring situated on the other side of the head of the screw.

The body of the screw comprises a smooth portion situated in proximity to the head of the screw and a threaded portion situated on the other side of the head of the screw.

The smooth portion and the threaded portion are situated to either side of the abutment of the screw.

The first threads of the threaded portion commence in immediate proximity to the abutment of the screw.

The axial length of the threaded portion of the screw is less than or equal to the total axial length of the internal bore of the inner ring.

The axial length of the threaded portion of the screw is less than or equal to the difference between the total axial length of the internal bore of the inner ring and the axial distance between the position of the second abutment and the radial side edge of the inner ring situated on the other side of the head of the screw.

The invention likewise relates to an internal combustion engine comprising at least one tensioning roller or winder device for a torque transmission element according to one of the embodiments mentioned above.

### BRIEF DESCRIPTION OF THE DRAWINGS

The invention will be better understood, and other advantages thereof will be appreciated more clearly, in the light of the following description of two unique embodiments exhibiting a tensioning roller or winder device consistent with its principle, which are given solely by way of example and are made with reference to the accompanying drawings:

FIG. 1 depicts a cross-sectional view of a roller accompanied by a screw according to a first embodiment;

FIG. 2 depicts a cross-sectional view of the tensioning roller in such a way as to depict the different geometrical parameters;

FIG. 3 depicts the screw according to the first embodiment in such a way as to depict the different geometrical parameters;

FIG. 4 depicts a screw according to a second embodiment; and

FIG. 5 depicts a cross-sectional view of a roller accompanied by a screw according to a third embodiment.

### DETAILED DESCRIPTION OF PARTICULAR EMBODIMENTS

A tensioning roller or winder is designated in its entirety with 1, and it has a central axis X1. The roller 1 comprises a pulley 2, a roller bearing 3 and a retaining screw 4, these elements being coaxial with the axis X1 in normal operating mode.

The screw 4 comprises the body 41 in the form of shank and a head 42 at one of the free extremities of the body 41. The body 41 comprises a smooth portion 41a, of which the outer cylindrical surface is smooth, in proximity to a head 42. The body 41 likewise comprises a threaded portion 41b on the side opposite the screw head 42.

The pulley 2 comprises an external part 21 exhibiting an outer cylindrical surface intended to interact with a torque transmission element (not illustrated) such as a belt or a chain. The pulley 2 likewise comprises an inner axial part 22 and a radial annular intermediate portion 23 connecting the inner 22 and outer 21 parts. The inner 22 and outer 21 parts are coaxial with the axis X1. The inner part 22 comprises a bore 22a, in which the roller bearing 3 is mounted.

The roller bearing 3 comprises an inner ring 31, an outer ring 32, two rows of rolling elements 33 and 34, being balls in this case, arranged in parallel planes maintained respectively by cages 35 and 36, and two seals 37 and 38.

The outer ring 31 comprises an outer cylindrical surface 31a that is consistent in shape with the bore 22a of the pulley 2. The pulley 2 is preferably moulded onto the outer ring 31. The outer ring 31 likewise comprises a bore 31b, in which are arranged roller bearing raceways for the rolling elements 33 and 34 and grooves into which the seals 37 and 38 are pressed, the seals forming a static seal with the rotating outer ring 31.

The inner ring 32 comprises an outer cylindrical surface 32a, in which are arranged roller bearing raceways for the rolling elements 33 and 34 and grooves in order to establish a contact with the seals 37 and 38, the seals forming a dynamic seal with the non-rotating inner ring 32.

The outer ring 31 is delimited axially by two radial side edges 31c and 31d at the front, and the inner ring is delimited axially par two radial side edges 32c and 32d at the front, in such a way that the side edges are respectively aligned axially.

The inner ring 32 likewise comprises a transcurrent cylindrical bore 32b, into which a body 41 of the retaining screw 4 is inserted. The bore 32b is a central opening passing axially through the inner ring 32 in its entirety and discharges at each of its extremities in the area of the radial side edges 32c and 32d. The threaded portion 41b of the body 41 projects axially in relation to the radial side edge 32d of the inner ring 32 and is intended to be inserted into a tapped hole arranged in a component that is intended to support the roller 1, in particular a wall of an engine block for a motor vehicle.

Axially on the opposite side, the inner ring comprises an opening 32e on the radial side edge 32c, of which the diameter and the depth are adapted in order to receive all or part of the head 42 of the screw 4, in such a way that the extremity of the head 42 of the screw does not extend axially beyond the pulley 2. Provision may likewise be made for the opening 32e to be dimensioned in such a way that the head 42 does not extend axially beyond the radial side edge 32c.

The opening 32e defines a radial side edge 32f intended to be in contact with the head 42 once the screw 4 has been inserted entirely into the bore 32b. The axial length between the side edges 32c and 32f is designated as L3.

Thanks to such an arrangement, it is possible to reduce the axial size of the roller 1 mounted on its support as well as the weight of the entire assembly.

In accordance with the invention, the bore 32b of the inner ring 32 comprises a first abutment 5a and a second abutment 5b. These two abutments 5a, 5b consist of a first shoulder and a second shoulder that are formed respectively at the axial extremities of a bearing 5c, of which the internal diameter D5 is smaller than the internal diameter D32 of the bore 32b.

The positions of the two abutments 5a, 5b of the bearing 5c in the bore 32b of the inner ring 32 are defined by axial distances L1 and L0 respectively between the position of the abutment 5a, 5b and the radial side edge 32d of the inner ring 32 situated on the side opposite the head 42 of the screw 4.

The axial length L for the accommodation of the body 41 of the screw 4 in the internal bore 32b is defined between the radial side edge 32d of the inner ring 32 situated on the side opposite the head 42 of the screw 4 and the radial side edge 32f of the inner ring 32, against which the head 42 of the screw 4 is intended to come into contact.

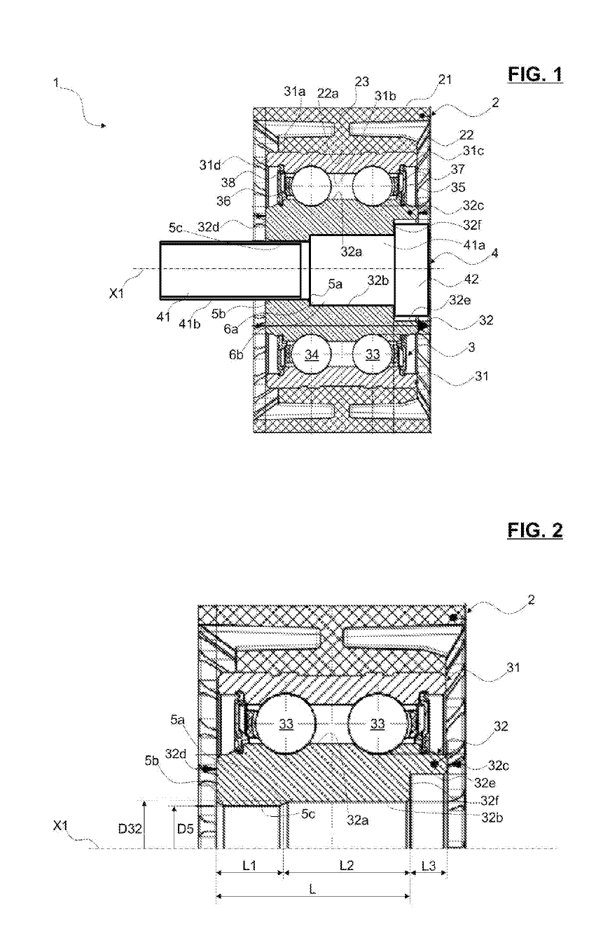

In the example illustrated in FIGS. 1 and 2, the position of the first abutment 5a in the bore 32b is such that the relationship between the axial distance L1 of the abutment 5a and the axial length L is equal to 0.35.

The axial length L2 is defined as being the distance between the first abutment 5a in the bore 32b and the radial side edge 32f of the inner ring 32, against which the head 42 of the screw 4 is intended to come into contact. The axial length L for the accommodation of the body 41 of the screw 4 in the internal bore 32b is thus equal to the sum of the axial lengths L1 and L2. The total axial length of the bore is equal to the sum of the axial lengths L and L3.

The second abutment 5b is a shoulder formed at the junction between the bearing 5c in the bore 32b and the radial side edge 32d of the inner ring 32 situated on the side opposite the head 42 of the screw 4, the axial length L0 being zero.

In accordance with the invention, the external periphery of the body 41 of the screw 4 comprises an abutment 6a. The abutment 6a consists of a shoulder formed at an axial extremity of a bearing 6c having an external diameter D6 that is greater than the external diameter D41 of the body 41 of the screw 4.

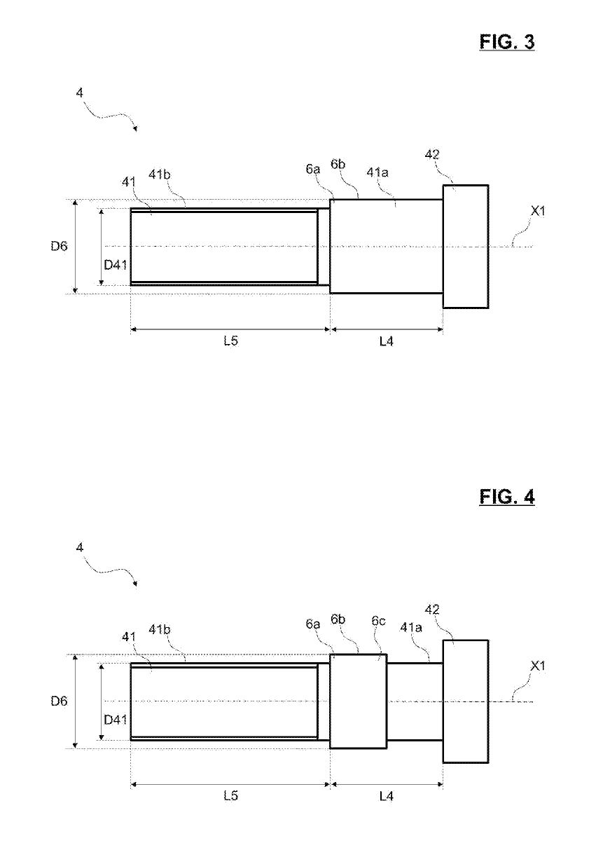

The smooth portion 41a and the threaded portion 41b are situated to either side of the abutment 6a of the screw 4. In the example depicted in FIGS. 1 and 3, the smooth portion 41a is carried by the bearing 6b. The first threads of the threaded portion 41b commence in immediate proximity to the abutment 6a of the screw 4.

The internal diameter D5 of the bearing 5c in the internal bore 32b of the inner ring 32 is substantially equal to the external diameter D6 of the corresponding bearing 6b of the body 41 of the screw 4. The internal diameter D32 of the internal bore 32b of the inner ring 32 is substantially equal to the external diameter D41 of the body 41 of the screw 4.

The axial length L4 between the head 42 and the abutment 6a of the screw 4 is equal to the axial length L2 between the radial side edge 32f of the inner ring 32, against which the head 42 of the screw 4 comes into contact, and the first abutment 5a in the bore 32b of the inner ring 32. As a result, when the screw 4 is inserted into the bore 32b in the desired direction, it is integrated completely into the bore 32b until abutment of the head 42 of the screw 4 takes place against the radial side edge 32f of the inner ring 32, and until contact of the abutment 6a of the screw 4 takes place against the first abutment 5a of the inner ring 32.

The axial length L4 between the head 42 and the abutment 6a of the screw 4 is at all times greater than the axial length L0 between the radial side edge 32d of the inner ring 32 opposite the head 42 of the screw 4 and the second abutment 6b in the bore 32b of the inner ring 32. Thus, when the screw 4 is not inserted into the bore 32b in the desired direction, it is not integrated completely into the bore 32b because the abutment 6a of the screw comes into contact with the second abutment 5b of the inner ring 32 situated at a distance smaller than the length that is necessary in order to be able insert fully the portion of the screw 4 that is comprised between the head 42 and the abutment 6a. In this case, the head 42 of the screw 4 protrudes from the bore 32b and is not capable of being inserted to a greater depth at that point, thus forming a means of keying.

In the example depicted in FIGS. 1 and 2, in which the second abutment 5b consists of a shoulder formed at the junction between the bearing 5c in the bore 32b and the radial side edge 32d of the inner ring 32 situated on the side opposite the head 42 of the screw 4, the abutment 6a of the screw 4 is then placed in contact against the shoulder 5b on the side edge 32d of the inner ring 32.

The threaded portion 41b of the screw 4 has an axial length L5 such that it is at all times greater than the axial length L1 between the first abutment 5a and the radial side edge 32d, in such a way as to protrude axially in relation to the radial side edge 32d of the inner ring 32.

This axial length L5 of the threaded portion 41 is likewise less than or equal to the total axial length of the internal bore of the inner ring, which is equal to the sum of the axial lengths L1, L2 and L3. As a result, when the screw 4 is inserted into the bore 32b in the undesired direction, the threaded portion 41b protrudes axially no more than partially in relation to the radial side edge 32c of the inner ring. In the example depicted in FIGS. 1 and 2, in which the second abutment 5b consists of a shoulder formed at the junction between the bearing 5c in the bore 32b and the radial side edge 32d of the inner ring 32 situated on the side opposite the head 42 of the screw 4, the threaded portion 41b does not extend axially beyond the radial side edge 32c in such a case. In the case of the incorrect insertion of the screw, it then becomes impossible to insert it into a tapped hole arranged, for example, in a part of a wall of an engine block for a motor vehicle, and therefore the tensioning roller 1 cannot be secured.

In accordance with a second embodiment illustrated in FIG. 4, in which the identical elements have the same references, the screw 4 differs from the previous embodiment in that the bearing 6b exhibits a first shoulder 6a forming an abutment for the insertion of the screw 4 into the bore 32b of the inner ring 32, and a second shoulder 6c.

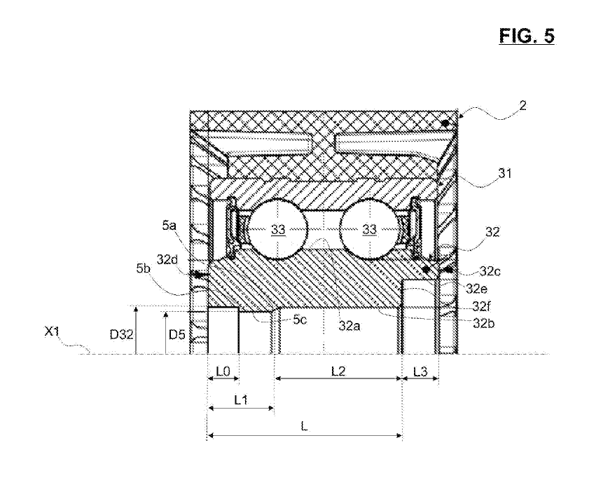

In accordance with a third embodiment illustrated in FIG. 5, in which the identical elements have the same references, the roller 1 differs from the preceding embodiment in that the second abutment 5b is a shoulder of the bearing 5c in the interior of the bore 32b having a non-zero axial length L0.

In a preferential manner, the axial length L5 of the threaded portion 41b of the screw 4 is less than or equal to the difference between the total axial length of the bore 32b (L1+L2+L3) and the axial distance L0 of the position of the second abutment 5b, corresponding to the axial distance between the second abutment 5b of the bearing 5c in the bore 32b of the inner ring 32 and the radial side edge 32c of the inner ring 32. Thus, regardless of the position of the second abutment 5b in the bore 32b, the threaded portion 41b does not extend axially beyond the radial side edge 32c in the case of the incorrect insertion of the screw.

The technical characteristics of the embodiments and variants envisaged above may be combined with each other.

1. A tensioning roller or winder device for a torque transmission element, the device comprising:
at least one roller bearing having:
an inner ring,
an outer ring, and
at least one row of rolling elements assembled between the inner and outer rings;
a pulley surmounting the outer ring;
a retaining screw comprising a body, intended to be inserted into a central bore of the inner ring, and a screw head;
a screw abutment provided on the external periphery of the body of the screw; and
a first inner ring bore abutment and a second inner ring bore abutment provided in the bore of the inner ring in such a way that:
an axial length between the screw head and the screw abutment is equal to an axial length between a radial side edge of the inner ring, against which the screw head is intended to come into contact, and the first abutment in the bore of the inner ring, and
the axial length between the screw head and the screw abutment is, at all times, greater than an axial length between a radial side edge of the inner ring opposite the screw head and the second abutment in the bore of the inner ring,
the screw abutment coming into contact with the first abutment of the inner ring at the time of the insertion of the screw body into the bore of the inner ring in the desired direction, but coming into contact with the second abutment of the inner ring at the time of the insertion of the screw body in the undesired direction.

2. The device according to claim 1, the inner ring further comprising, on a radial side edge, an opening of which a diameter and a depth are adapted in order to receive at least part of the screw head in such a way that the extremity of the screw head does not extend axially beyond at least one of the roller bearing and the pulley.

3. The device according to claim 1, the first abutment and the second abutment formed in the central bore of the inner ring further comprises a first shoulder and a second shoulder formed respectively on the axial extremities of a bearing,
wherein an internal diameter of the axial extremity is less than an internal diameter of the central bore of the inner ring.

4. The device according to claim 1, the abutment formed on the body of the screw further comprises a shoulder formed at one axial extremity of the bearing, wherein the shoulder has an external diameter that is greater than the external diameter of the screw body.

5. The device according to claim 1, wherein the position of each abutment of the bearing in the bore of the inner ring is defined by an axial distance between the position of the abutment and the radial side edge of the inner ring situated on the other side of the screw head, in such a way that the positional relationship between this axial distance in the position of the abutment and the axial length of the internal bore between the radial side edge of the inner ring situated on the other side of the screw head, and the radial side edge of the inner ring, against which the screw head is intended to come into contact lies in the range between 0 and 0.5.

6. The device according to claim 1, wherein the second abutment is a shoulder formed at the junction between the bearing in the bore and the radial side edge of the inner ring situated on the other side of the screw head.

7. The device according to claim 1, wherein first threads of a threaded portion commence in immediate proximity to the screw abutment.

8. The device according to claim 1, wherein the axial length of a threaded portion of the screw is one of less than or equal to a total axial length of the internal bore of the inner ring.

9. The device according to claim 8, wherein the axial length of the threaded portion of the screw is one of less than or equal to the difference between the total axial length of the internal bore of the inner ring and the axial distance between the position of the second abutment and the radial side edge of the inner ring situated on the other side of the screw head.

10. An internal combustion engine comprising at least one tensioning roller or winder device for a torque transmission element, wherein each of the at least one tensioning roller or winder device comprises:
at least one roller bearing having:
an inner ring,
an outer ring, and
at least one row of rolling elements assembled between the inner and outer rings;
a pulley surmounting the outer ring;
a retaining screw comprising a body, intended to be inserted into a central bore of the inner ring, and a screw head;
a screw abutment provided on the external periphery of the body of the screw; and
a first inner ring bore abutment and a second inner ring bore abutment provided in the bore of the inner ring in such a way that:
an axial length between the screw head and the screw abutment is equal to an axial length between a radial side edge of the inner ring, against which the screw head is intended to come into contact, and the first abutment in the bore of the inner ring, and
the axial length between the screw head and the screw abutment is, at all times, greater than an axial length between a radial side edge of the inner ring opposite the screw head and the second abutment in the bore of the inner ring,
the screw abutment coming into contact with the first abutment of the inner ring at the time of the insertion of the screw body into the bore of the inner ring in the desired direction, but coming into contact with the second abutment of the inner ring at the time of the insertion of the screw body in the undesired direction,
wherein the each of the at least one tensioning roller or winder device is in operational communication with the torque transmission element of the internal combustion engine.
